(19) United States
(12) Patent Application Publication
(10) Pub. No.: US 2020/0360741 A1
(43) Pub. Date: Nov. 19, 2020

(54) TOOL CABINET

(71) Applicant: Chia-Ming LIU, Douliou City (TW)

(72) Inventor: Chia-Ming LIU, Douliou City (TW)

(21) Appl. No.: 16/863,862

(22) Filed: Apr. 30, 2020

(30) Foreign Application Priority Data
May 15, 2019 (CN) 201920694131.2

(51) Int. Cl. A62C 3/00; B25H 3/02; B32B 13/04

(52) U.S. Cl. CPC A62C 3/002; B25H 3/028; B32B 2307/3065; B32B 2264/102; B32B 2315/18; B32B 13/047

(57) ABSTRACT

A tool cabinet includes a main body, a shielding unit, and first and second fire resistance subunits. The main body defines a first receiving space and at least one second receiving space. The first fire resistance subunit is made of a fire-resistant material, and is disposed in the first receiving space. The second fire resistance subunit is mounted co-movably to a front door of the shielding unit, and has a front fire resistance layer made of a fire-resistant material. The front fire resistance layer and the first fire resistance subunit form a hollow shell structure when the front door is at a close position. An internal space of the hollow shell structure is isolated from the second receiving space.

### CROSS-REFERENCE TO RELATED APPLICATION

This application claims priority of Chinese Utility Model Patent Application No. 201920694131.2, filed on May 15, 2019.

### FIELD

The disclosure relates to a tool cabinet, more particularly to a tool cabinet with fire-resistant storage.

### BACKGROUND

A conventional tool cabinet is used to store tools and equipment and is usually made of a metallic material. Even though the conventional tool cabinet is structurally durable, the metallic material may melt and lose structure when exposed to high temperatures in a fire. Furthermore, since metallic materials are good thermal conductors, heat is easily transmitted to inside internal spaces of the conventional tool cabinet. As such, the tools and equipment stored therein cannot be protected from the heat in a fire.

### SUMMARY

Therefore, the object of the disclosure is to provide a tool cabinet that can alleviate the drawback of the prior art.

According to the disclosure, a tool cabinet includes a main body, a shielding unit, and a fire resistance unit.

The main body includes a rear wall, a surrounding wall extending forwardly from a periphery of the rear wall, and a separating wall extending forwardly from the rear wall and being connected to an inner surface of the surrounding wall. The rear wall, the surrounding wall and the separating wall cooperatively define a first receiving space and at least one second receiving space that open forwardly.

The shielding unit includes a front door movable between a close position, where the front door covers a front open end of the first receiving space, and an open position, where the front door uncovers the front open end of the first receiving space.

The fire resistance unit includes a first fire resistance subunit and a second fire resistance subunit.

The first fire resistance subunit is made of a fire-resistant material, is disposed in the first receiving space, and is mounted to the rear wall, the surrounding wall, and the separating wall. The second fire resistance subunit is mounted co-movably to an end of the front door which faces the first receiving space, and has a front fire resistance layer made of a fire-resistant material. The front fire resistance layer and the first fire resistance subunit form a hollow shell structure when the front door is at the close position. An internal space of the hollow shell structure is isolated from the second receiving space.

### BRIEF DESCRIPTION OF THE DRAWINGS

Other features and advantages of the disclosure will become apparent in the following detailed description of the embodiment with reference to the accompanying drawings, of which:

FIG. 1 is a perspective view of an embodiment of a tool cabinet according to the disclosure;

FIG. 2 is side view of the embodiment;

FIG. 3 is a schematic sectional view of the embodiment taken along line III-III in FIG. 1;

FIG. 4 is a schematic sectional view of the embodiment taken along line IV-IV in FIG. 2;

FIG. 5 is a schematic sectional view of the embodiment taken along line V-V in FIG. 2; and

FIG. 6 is a perspective view of the embodiment illustrating a front door of the embodiment at an open position.

### DETAILED DESCRIPTION

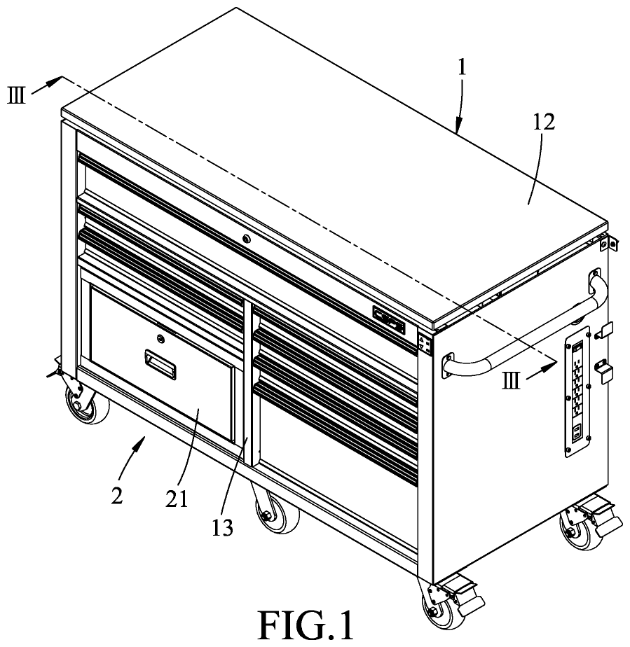

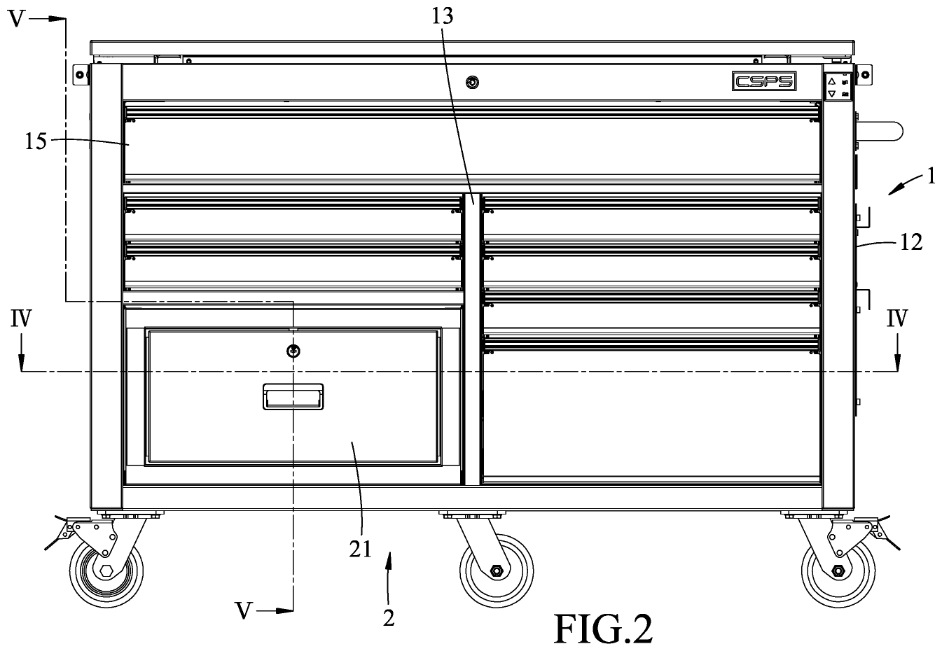

Referring to FIGS. 1 to 3, an embodiment of a tool cabinet includes a main body 1, a shielding unit 2, a fire resistance unit 3, and a drawer unit 4.

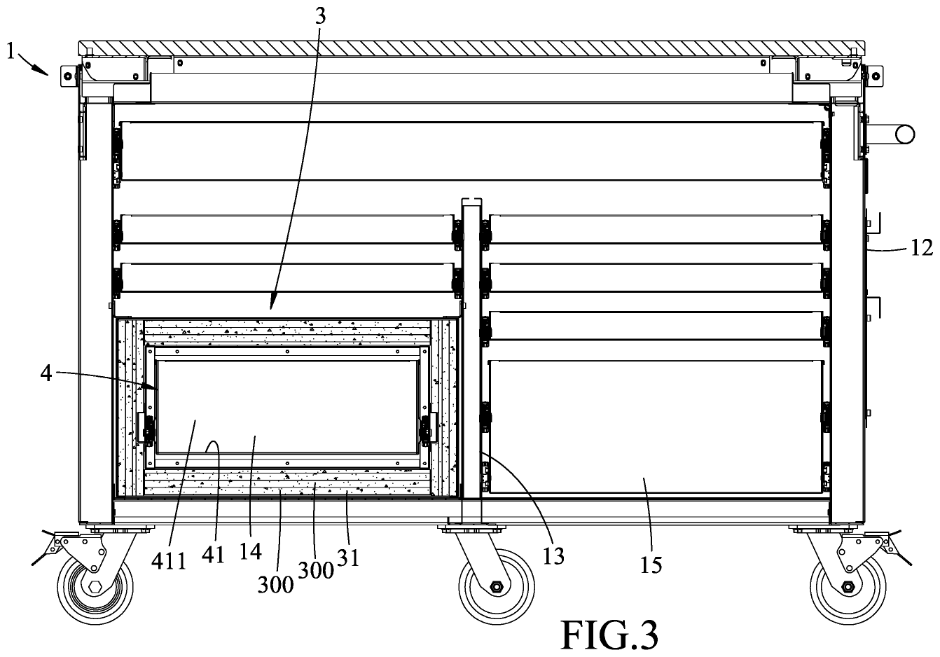

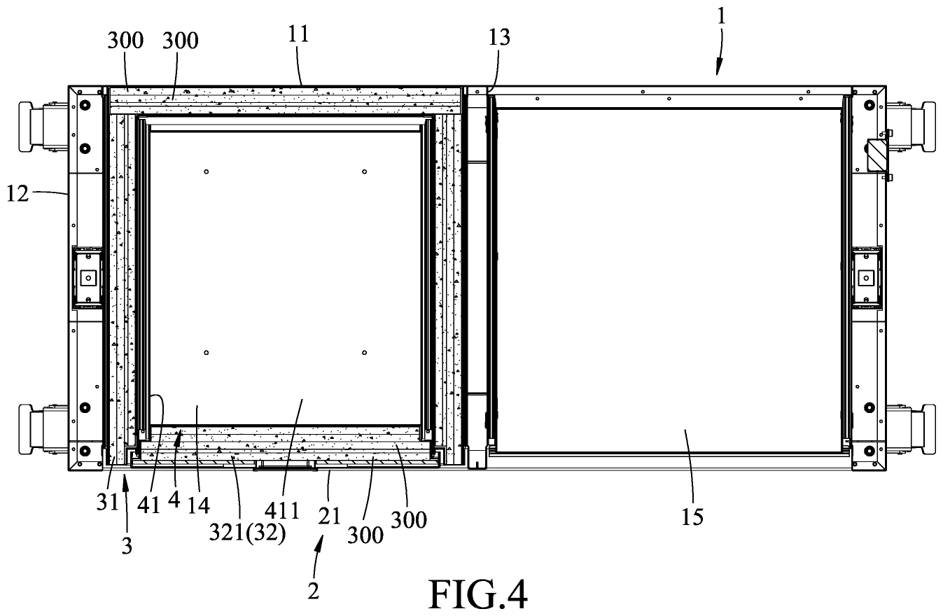

Referring to FIGS. 3 and 4, the main body 1 opens forwardly and includes a rear wall 11, a surrounding wall 12 extending forwardly from a periphery of the rear wall 11, and a separating wall 13 extending forwardly from the rear wall 11 and being connected to an inner surface of the surrounding wall 12. The rear wall 11, the surrounding wall 12 and the separating wall 13 cooperatively define a first receiving space 14 and at least one second receiving space 15 that open forwardly.

In this embodiment, the separating wall 13 extends upwardly from a bottom part of the surrounding wall 12. The first receiving space 14 is disposed at a side of the separating wall 13 and has a height which is lower than or equal to that of the separating wall 13. The second receiving space 15 may receive a plurality of drawers therein or be divided by smaller walls connected between the separation wall 13 and the surrounding wall 12. In this embodiment, the second receiving space 15 receives seven drawers therein.

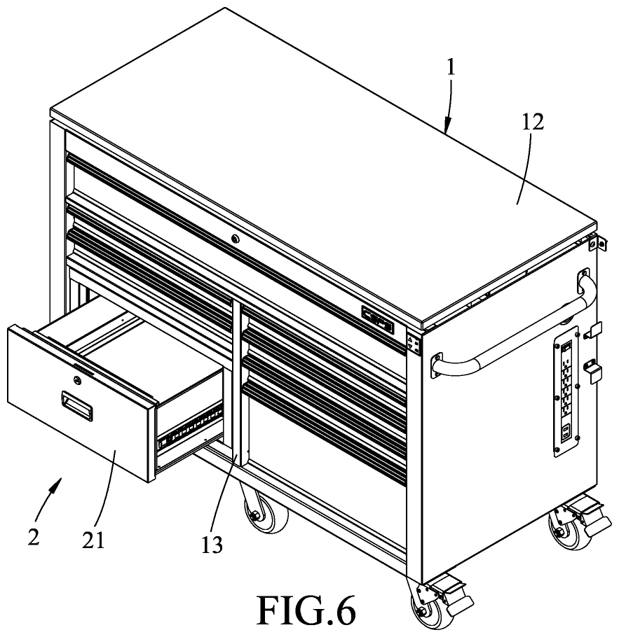

The shielding unit 2 includes a front door 21 movable between a close position, where the front door 21 covers a front open end of the first receiving space 14, and an open position (see FIG. 6), where the front door 21 uncovers the front open end of the first receiving space 14.

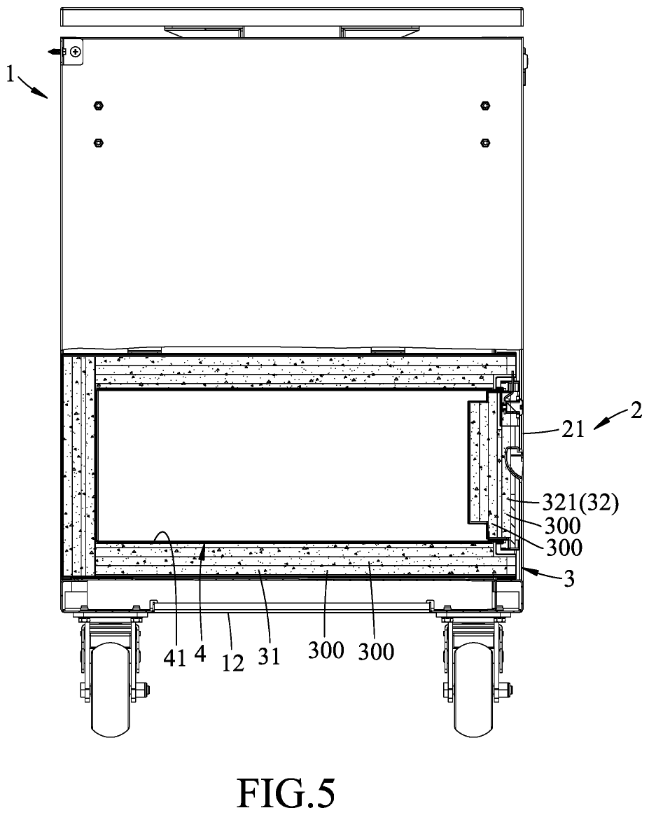

Referring to FIGS. 3 to 5, the fire resistance unit 3 includes a first fire resistance subunit 31 and a second fire resistance subunit 32.

The first fire resistance subunit 31 is made of a fire-resistant material, is disposed in the first receiving space 14, and is mounted to the rear wall 11, the surrounding wall 12, and the separating wall 13.

The second fire resistance subunit 32 is mounted co-movably to an end of the front door 21 which faces the first receiving space 14, and has a front fire resistance layer 321 made of a fire-resistant material. The front fire resistance layer 321 and the first fire resistance subunit 31 form a hollow shell structure when the front door 21 is at the close position. An internal space in the hollow shell structure is isolated from the second receiving space 15.

In this embodiment, each of the first fire resistance subunit 31 and the front fire layer 321 includes a plurality of calcium silicate boards 300. In other embodiments, each of the first fire resistance subunit 31 and the front fire resistance layer 321 is made of, for example, expanded perlite, fire-resistant gypsum plasterboard, concrete, or includes at least one magnesium oxide board.

The drawer unit 4 including a drawer 41 connected co-movably to the second fire resistance subunit 32 and the front door 21, and cooperating with the front fire resistance layer 321 of the second fire resistance subunit 32 to define a drawer space 411. The drawer 41 is retained in the internal space of the hollow shell structure when the front door 21 is at the close position, and extends out of the first receiving space 14 when the front door 21 is at the open position.

In practical use, an object to be protected (not shown) may be placed into the drawer space 411 when the front door 21 is moved to the open position and the drawer 41 extends out of the first receiving space 14. Once the front door 21 is moved to the close position and the drawer 41 is retained in the hollow shell structure, the object to be protected is received in the hollow shell structure.

As the first fire resistance subunit 31 and the front fire resistance layer 321 are made of fire-resistant materials, when the object to be protected is surrounded completely by the hollow shell structure, it is protected from high temperatures caused by external fires. This reduces damage to the object due to the high temperatures.

When storing tools and equipment in the tool cabinet, more expensive or important tools and equipment may be placed in the drawer 41 to be in the hollow shell structure while other tools are placed in the second receiving spaces 15, allowing the tool cabinet to have both regular storage and fire-resistant storage capabilities.

In this embodiment, the drawer space 411 of the drawer 41 receives the object to be protected, but in a variation of this embodiment, the drawer unit 4 may be omitted and the object to be protected may be placed directly into the hollow shell structure, so long as the first and second fire resistance subunits 31, 32 form the hollow shell structure to protect the object therein.

In certain embodiments (not shown), the first fire resistance subunit 31 has first and second fire resistance layers, and a middle layer disposed in between the first and second fire resistance layers. The first fire resistance layer is directly connected to the rear wall 11, the surrounding wall 12, and the separation wall 13. The first and second fire resistance layers are made of a fire-resistant material and may be made of the same or different materials, for example, expanded perlite, fire-resistant gypsum plasterboard, magnesium oxide board, concrete, etc., and the middle layer may be made of a material with stronger structural strength such as a steel plate or a metal net. The function of the middle layer is to improve the structural integrity of the first fire resistance subunit 31 and to prevent the first and second fire resistance layers from collapsing after being heated and losing fire resistance functions.

In the description above, for the purposes of explanation, numerous specific details have been set forth in order to provide a thorough understanding of the embodiment. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects, and that one or more features or specific details from one embodiment may be practiced together with one or more features or specific details from another embodiment, where appropriate, in the practice of the disclosure.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A tool cabinet comprising:
a main body including a rear wall, a surrounding wall that extends forwardly from a periphery of said rear wall, and a separating wall that extends forwardly from said rear wall and that is connected to an inner surface of said surrounding wall, said rear wall, said surrounding wall and said separating wall cooperatively defining a first receiving space and at least one second receiving space that open forwardly;
a shielding unit including a front door that is movable between a close position, where said front door covers a front open end of said first receiving space, and an open position, where said front door uncovers said front open end of said first receiving space; and
a fire resistance unit including
a first fire resistance subunit that is made of a fire-resistant material, that is disposed in said first receiving space, and that is mounted to said rear wall, said surrounding wall, and said separating wall, and
a second fire resistance subunit that is mounted co-movably to an end of said front door which faces said first receiving space, and that has a front fire resistance layer made of a fire-resistant material, said front fire resistance layer and said first fire resistance subunit forming a hollow shell structure when said front door is at the close position, an internal space of said hollow shell structure being isolated from said second receiving space.

2. The tool cabinet as claimed in claim 1, wherein each of said first fire resistance subunit and said front fire layer includes at least one calcium silicate board.

3. The tool cabinet as claimed in claim 2, further comprising a drawer unit including a drawer that is connected co-movably to said second fire resistance subunit and said front door, and that cooperates with said second fire resistance subunit to define a drawer space, said drawer being retained in said hollow shell structure when said front door is at the close position, said drawer extending out of said first receiving space when said front door is at the open position.

4. The tool cabinet as claimed in claim 1, wherein said first fire resistance subunit and said front fire resistance layer are made of expanded perlite.

5. The tool cabinet as claimed in claim 1, wherein said first fire resistance subunit and said front fire resistance layer are made of fire-resistant gypsum plasterboard.

6. The tool cabinet as claimed in claim 1, wherein each of said first fire resistance subunit and said front fire resistance layer includes at least one magnesium oxide board.
